(19) United States
(12) Patent Application Publication
(10) Pub. No.: US 2019/0042443 A1
(43) Pub. Date: Feb. 7, 2019

(54) DATA ACQUISITION WITH ZERO COPY PERSISTENT BUFFERING

(71) Applicant: Intel Corporation, Santa Clara, CA (US)

(72) Inventors: Maciej MACIEJEWSKI, Gdansk (PL); Piotr PELPINSKI, Sopot (PL); Grzegorz JERECZEK, Gdansk (PL); Jakub RADTKE, Gdansk (PL); Wojciech MALIKOWSKI, Gdansk (PL); Pawel MAKOWSKI, Gdansk (PL)

(21) Appl. No.: 15/910,938

(22) Filed: Mar. 2, 2018

(51) Int. Cl. G06F 12/0871; G06F 12/0811

(52) U.S. Cl. CPC G06F 12/0871; G06F 2212/283; G06F 2212/1044; G06F 12/0811

(57) ABSTRACT

Examples may include techniques to manage data in a data acquisition system including allocating memory in a first stage buffer; storing data received by a data provider into the allocated memory in the first stage buffer; and storing a key identifying the stored data and an address in the first stage buffer for the stored data in an entry in a first keys data structure. Further steps include receiving a request from a filtering unit to get the stored data from the first stage buffer, the request including the key; retrieving the address in the first stage buffer from the entry in the first keys data structure associated with the key; and returning the address in the first stage buffer to the filtering unit. Further steps include receiving a request to store at least a portion of the stored data in a second stage buffer, the request including the key; moving the at least a portion of the stored data from the first stage buffer to the second stage buffer; moving the key from the first keys data structure to a second keys data structure; updating an address for the second stage buffer of the at least a portion of the stored data in the second keys data structure; and freeing memory allocated to the stored data in the first stage buffer.

### TECHNICAL FIELD

Examples described herein are generally related to managing the acquisition and storage of data in a computing system.

### BACKGROUND

Data acquisition is the process of sampling signals that measure real world physical conditions and converting the resulting samples into digital numeric values that can be manipulated by a computing system. A data acquisition system (DAQ) is a collection of software and hardware that measures or controls physical characteristics of something in the real world. A complete data acquisition system typically consists of DAQ hardware, sensors and actuators, signal conditioning hardware, and a computing platform running DAQ software (SW). Data acquisition systems convert analog waveforms into digital values for further processing using components such as: a) sensors to convert physical parameters to electrical signals; b) signal conditioning circuitry to convert sensor signals into a form that can be converted to digital values; and (c) analog-to-digital converters to convert conditioned sensor signals to digital values. Data acquisition applications are usually controlled by software programs developed using various general-purpose programming languages.

Some DAQ systems collect data from a very large number of sensors. In some scenarios, the amount of data generated by the sensors is enormous. For example, for high energy physics experiments, the data readout from thousands of sensors with a rate of several mega Hertz (MHz) can approach tens of terabytes per second (TB/s). In some cases, the experiments may be run continuously for several hours at a time with a break between consecutive runs. Such extremely large amounts of data must be processed by a very large computing system, where data filtering must be performed in real-time. The cost of such a very large computing system is strongly correlated with the size of a temporal buffer in memory for storing the incoming data. However, the cost of exa-scale multi-hour buffering can become prohibitive and is usually not considered when designing DAQ systems.

Some data buffering systems currently in use are based on a known Log-Structured-Merge-Tree (LSM-Tree) approach, however this approach has at least several disadvantages. The use of LSM-Tree is not feasible for large DAQ systems because of LSM-Tree's requirements of a massive size of random access memory (RAM) on multiple storage nodes t handle TBs of data per second. The LSM-Tree approach is optimized for data insertion operations (e.g., writes), while retrieve operations (e.g., reads) are also crucial for the operational success of the large DAQ system. The LSM-Tree approach does not help with any filtering steps. That is, the acquired data is copied multiple times when moving between LST Tree levels.

Thus, better approaches to handling the acquisition and management of the data in large DAQs is needed.

### BRIEF DESCRIPTION OF THE DRAWINGS

FIG. 1 illustrates an example computing system.

FIG. 2 illustrates an example data acquisition system.

FIG. 3 illustrates example data acquisition system components.

FIG. 4 illustrates an example of a logic flow for a first Put operation.

FIG. 5 illustrates an example of a logic flow for a Get operation.

FIG. 6 illustrates an example of a logic flow for a second Put operation.

FIG. 7 illustrates an example of a logic flow for a Delete operation.

FIG. 8 illustrates an example of a storage medium.

FIG. 9 illustrates an example computing platform.

### DETAILED DESCRIPTION

As contemplated in the present disclosure, embodiments of the present invention leverage the use of non-volatile, persistent memory to build a two-level buffering system. A first stage buffer may receive all of the acquired data, and store the data within one or more persistent memories. The data may be processed by a filtering unit to significantly reduce the size of the data. After filtering, most of the data is discarded, and the remaining data may be moved to a second stage buffer in the persistent memory or in a storage device having a non-volatile memory (NVM), where further processing of the data may then be performed.

Embodiments of the present invention enable a new approach in DAQ system architecture. Benefits may include cost reduction, higher data bandwidth, and more flexibility in computing system software implementations. In addition, computing system efficiency may be increased due to enlarging the time window for event filtering while processing the data.

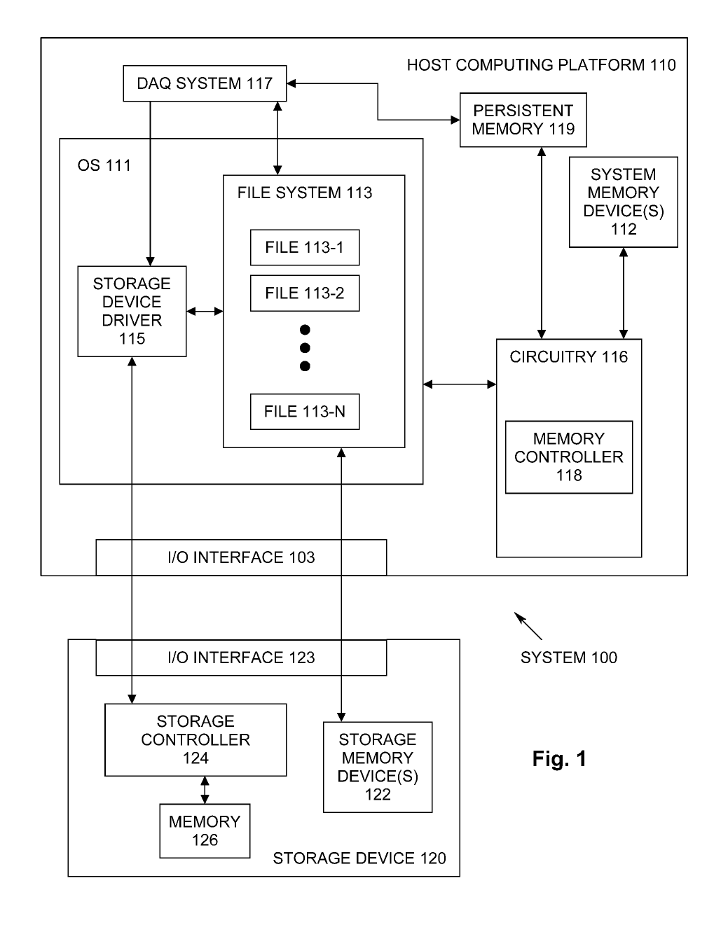

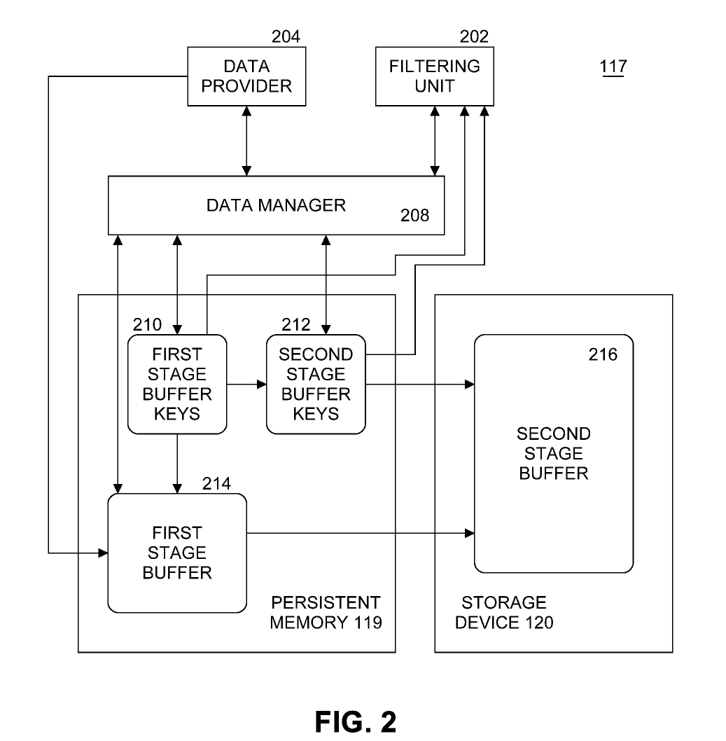

FIG. 1 illustrates an example computing system. In some examples, as shown in FIG. 1, system 100 includes a host computing platform 110 coupled to one or more storage device(s) 120 through I/O interface 103 and I/O interface 123. Also, as shown in FIG. 2, host computing platform 110 may include an OS 111, one or more system memory device(s) 112, circuitry 116 and DAQ system 117 to manage the acquisition, storage, and processing of DAQ data. For these examples, circuitry 116 may be capable of executing various functional elements of host computing platform 110 such as OS 111 and DAQ system 117 that may be maintained, at least in part, within system memory device(s) 112. Circuitry 116 may include host processing circuitry to include one or more central processing units (CPUs) (not shown) and associated chipsets and/or controllers.

According to some examples, as shown in FIG. 1, OS 111 may include a file system 113 and a storage device driver 115 and storage device 120 may include a storage controller 124, one or more storage memory device(s) 122 and memory 126. OS 111 may be arranged to implement storage device driver 115 to coordinate at least temporary storage of data for a file from among files 113-1 to 113-n, where “n” is any whole positive integer>1, to storage memory device(s) 122. The data, for example, may have originated from or may be associated with executing at least portions of DAQ system 117 and/or OS 111, or application programs (not shown in FIG. 2). As described in more detail below, OS 111 communicates one or more commands and transactions with storage device 120 to write data to storage device 120. The commands and transactions may be organized and processed by logic and/or features at the storage device 120 to write the data to storage device 120.

In some examples, storage controller 124 may include logic and/or features to receive a write transaction request to storage memory device(s) 122 at storage device 120. For these examples, the write transaction may be initiated by or sourced from DAQ system 117 that may, in some embodiments, utilize file system 113 to write data to storage device 120 through input/output (I/O) interfaces 103 and 123.

In some examples, memory 126 may include volatile types of memory including, but not limited to, RAM, D-RAM, DDR SDRAM, SRAM, T-RAM or Z-RAM. One example of volatile memory includes DRAM, or some variant such as SDRAM. A memory subsystem as described herein may be compatible with a number of memory technologies, such as DDR4 (DDR version 4, initial specification published in September 2012 by JEDEC), LPDDR4 (LOW POWER DOUBLE DATA RATE (LPDDR) version 4, JESD209-4, originally published by JEDEC in August 2014), WIO2 (Wide I/O 2 (WideIO2), JESD229-2, originally published by JEDEC in August 2014), HBM (HIGH BANDWIDTH MEMORY DRAM, JESD235, originally published by JEDEC in October 2013), DDR5 (DDR version 5, currently in discussion by JEDEC), LPDDR5 (LPDDR version 5, currently in discussion by JEDEC), HBM2 (HBM version 2, currently in discussion by JEDEC), and/or others, and technologies based on derivatives or extensions of such specifications.

However, examples are not limited in this manner, and in some instances, memory 126 may include non-volatile types of memory, whose state is determinate even if power is interrupted to memory 126. In some examples, memory 126 may include non-volatile types of memory that is a block addressable, such as for NAND or NOR technologies. Thus, memory 126 can also include a future generation of types of non-volatile memory, such as a 3-dimensional cross-point memory (3D XPoint™), or other byte addressable non-volatile types of memory. According to some examples, memory 126 may include types of non-volatile memory that includes chalcogenide glass, multi-threshold level NAND flash memory, NOR flash memory, single or multi-level Phase Change Memory (PCM), a resistive memory, nanowire memory, FeTRAM, MRAM that incorporates memristor technology, or STT-MRAM, or a combination of any of the above, or other memory.

In some examples, storage memory device(s) 122 may be a device to store data from write transactions and/or write operations. Storage memory device(s) 122 may include one or more chips or dies having gates that may individually include one or more types of non-volatile memory to include, but not limited to, NAND flash memory, NOR flash memory, 3-D cross-point memory (3D XPoint™), ferroelectric memory, SONOS memory, ferroelectric polymer memory, FeTRAM, FeRAM, ovonic memory, nanowire, EEPROM, phase change memory, memristors or STT-MRAIVI. For these examples, storage device 120 may be arranged or configured as a solid-state drive (SSD). The data may be read and written in blocks and a mapping or location information for the blocks may be kept in memory 126.

According to some examples, communications between storage device driver 115 and storage controller 124 for data stored in storage memory devices(s) 122 and accessed via files 113-1 to 113-n may be routed through I/O interface 103 and I/O interface 123. I/O interfaces 103 and 123 may be arranged as a Serial Advanced Technology Attachment (SATA) interface to couple elements of host computing platform 110 to storage device 120. In another example, I/O interfaces 103 and 123 may be arranged as a Serial Attached Small Computer System Interface (SCSI) (or simply SAS) interface to couple elements of host computing platform 110 to storage device 120. In another example, I/O interfaces 103 and 123 may be arranged as a Peripheral Component Interconnect Express (PCIe) interface to couple elements of host computing platform 110 to storage device 120. In another example, I/O interfaces 103 and 123 may be arranged as a Non-Volatile Memory Express (NVMe) interface to couple elements of host computing platform 110 to storage device 120. For this other example, communication protocols may be utilized to communicate through I/O interfaces 103 and 123 as described in industry standards or specifications (including progenies or variants) such as the Peripheral Component Interconnect (PCI) Express Base Specification, revision 3.1, published in November 2014 (“PCI Express specification” or “PCIe specification”) or later revisions, and/or the Non-Volatile Memory Express (NVMe) Specification, revision 1.2, also published in November 2014 (“NVMe specification”) or later revisions.

In some examples, system memory device(s) 112 may store information and commands which may be used by circuitry 116 for processing information. Also, as shown in FIG. 1, circuitry 116 may include a memory controller 118. Memory controller 118 may be arranged to control access to data at least temporarily stored at system memory device(s) 112 for eventual storage to storage memory device(s) 122 at storage device 120.

In some examples, storage device driver 115 may include logic and/or features to forward commands associated with one or more read or write transactions and/or read or write operations originating from DAQ system 117. For example, the storage device driver 115 may forward commands associated with write transactions such that data may be caused to be stored to storage memory device(s) 122 at storage device 120. More specifically, storage device driver 115 can enable communication of the write operations from DAQ system 117 at computing platform 110 to controller 124.

System Memory device(s) 112 may include one or more chips or dies having volatile types of memory such RAM, D-RAM, DDR SDRAM, SRAM, T-RAM or Z-RAM. However, examples are not limited in this manner, and in some instances, system memory device(s) 112 may include non-volatile types of memory, including, but not limited to, NAND flash memory, NOR flash memory, 3-D cross-point memory (3D XPoint™), ferroelectric memory, SONOS memory, ferroelectric polymer memory, FeTRAM, FeRAM, ovonic memory, nanowire, EEPROM, phase change memory, memristors or STT-MRAM.

Persistent memory 119 may include one or more chips or dies having non-volatile types of memory, including, but not limited to, NAND flash memory, NOR flash memory, 3-D cross-point memory (3D XPoint™), ferroelectric memory, SONOS memory, ferroelectric polymer memory, FeTRAM, FeRAM, ovonic memory, nanowire, EEPROM, phase change memory, memristors or STT-MRAM.

According to some examples, host computing platform 110 may include, but is not limited to, a server, a server array or server farm, a web server, a network server, an Internet server, a work station, a mini-computer, a main frame computer, a supercomputer, a network appliance, a web appliance, a distributed computing system, a personal computer, a tablet computer, a smart phone, multiprocessor systems, processor-based systems, or combination thereof.

FIG. 2 illustrates an example data acquisition (DAQ) system 117. DAQ system 117 may include one or more data providers 204 to obtain data from external sensors or other data gathering equipment outside of host computing platform 110. One or more filtering units 202 may filter received data to reduce the amount of data kept for further DAQ processing. In an embodiment, filtering unit 202 may process data by any one or more of known data filtering methods. In an embodiment, data manager 208 may provide an interface (e.g., an application programming interface (API)) to filter unit 202 and data provider 204 for directing the flow of data within DAQ system 117. Data manager 208 may also include event handling capabilities for managing the flow of data between filtering unit 202, data provider 204, persistent memory 119, and storage device 120.

In embodiments, DAQ system 117 manages two buffers—a first stage buffer 214 and a second stage buffer 216. Associated with data stored in each buffer are keys that identify the data and buffer addresses in first stage buffer and/or second stage buffer where the data is stored. A set of first stage buffer keys 210 comprises a data structure for storing keys and buffer addresses identifying locations in first stage buffer 214. Each entry in first stage buffer keys 210 comprises a key and a buffer address in first stage buffer 214. A set of second stage buffer keys 212 comprises a data structure for storing keys and buffer addresses identifying locations in second stage buffer 216. Each entry in second stage buffer keys 212 comprises a key and a buffer address in second stage buffer 216. In at least one embodiment, first stage buffer 214, first stage buffer keys 210, and second stage buffer keys 212 may be stored in persistent memory 119. In at least one embodiment, second stage buffer 216 may be stored in storage device 120. In another embodiment, second stage buffer 216 may be stored in system memory device 112.

In one embodiment, first stage buffer 214 may store incoming data which has not yet been subject to any filtering. Second stage buffer 216 may store data that has been filtered. Generally, any suitable data structures may be used for the first and second stage buffers, such as trees or hashes. In one embodiment, first stage buffer 214 may include a data structure comprising a hash table. In one embodiment, second stage buffer 216 may include a data structure comprising a B+ tree.

The following sequence of operations defines data flows subject to optimization in DAQ system 117 according to embodiments of the present invention.

1) a first Put operation to receive and store incoming data from data provider 204.

2) a Get operation to get data from first stage buffer 214 for processing by filtering unit 202.

3) a second Put operation to trigger the movement of one or more keys and buffer addresses from first stage buffer keys 210 to second stage buffer keys 212 for data that has passed through a filtering process by filtering unit 202.

4) a Delete operation to trigger removal of data from first stage buffer 214 for data that has not passed through a filtering process by filtering unit 202.

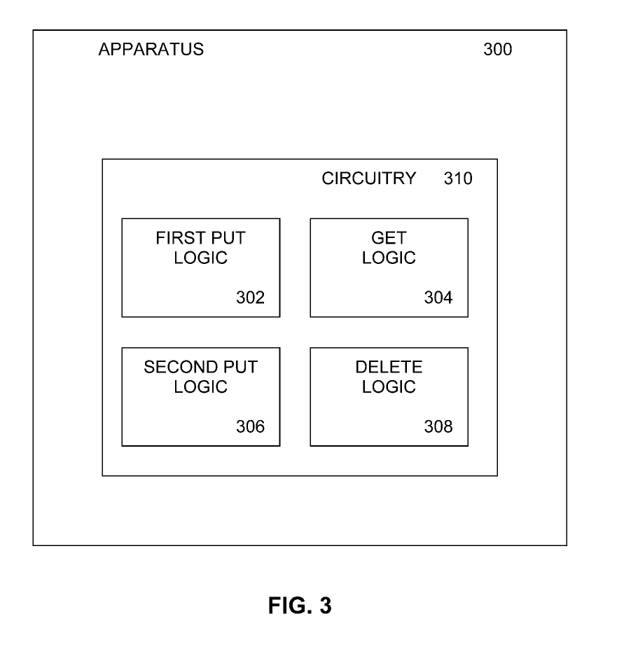

FIG. 3 illustrates an example block diagram for an apparatus 300. Although apparatus 300 shown in FIG. 3 has a limited number of elements in a certain topology, it may be appreciated that the apparatus 300 may include more or less elements in alternate topologies as desired for a given implementation.

According to some examples, apparatus 300 may be associated with logic and/or features of processing logic (e.g., DAQ system 117 as shown in FIGS. 1 and 2) hosted by a computing platform 101 and may be supported by circuitry 310. For these examples, circuitry 310 may be incorporated within circuitry, processor circuitry, a processing element, a CPU or a core maintained at the computing platform 101. Circuitry 310 may be arranged to execute one or more software, firmware or hardware implemented modules, components or logic 302, 304, 306, and 308. Module, component or logic may be used interchangeably in this context. The examples presented are not limited in this context and the different variables used throughout may represent the same or different integer values. Also, “logic”, “module” or “component” may also include software/firmware stored in computer-readable media, and although the types of logic are shown in FIG. 3 as discrete boxes, this does not limit these components to storage in distinct computer-readable media components (e.g., a separate memory, etc.).

According to some examples, circuitry 310 may include a processor, processor circuit, processor circuitry, processor element, core or CPU. Circuitry 310 may be generally arranged to execute or implement one or more modules, components or logic 302, 304, 306, and 308. Circuitry 310 may be all or at least a portion of any of various commercially available processors, including without limitation an Intel® Atom®, Celeron®, Core (2) Duo®, Core i3, Core i5, Core i7, Itanium®, Pentium®, Xeon®, Xeon Phi® and XScale® processors; or similar processors. According to some examples, circuitry 310 may include an application specific integrated circuit (ASIC) and at least some logic 302, 304, 306, and 308 may be implemented as hardware elements of the ASIC. According to some examples, circuitry 310 may include a field programmable gate array (FPGA) and at least some logic 302, 304, 306, and 308 may be implemented as hardware elements of the FPGA.

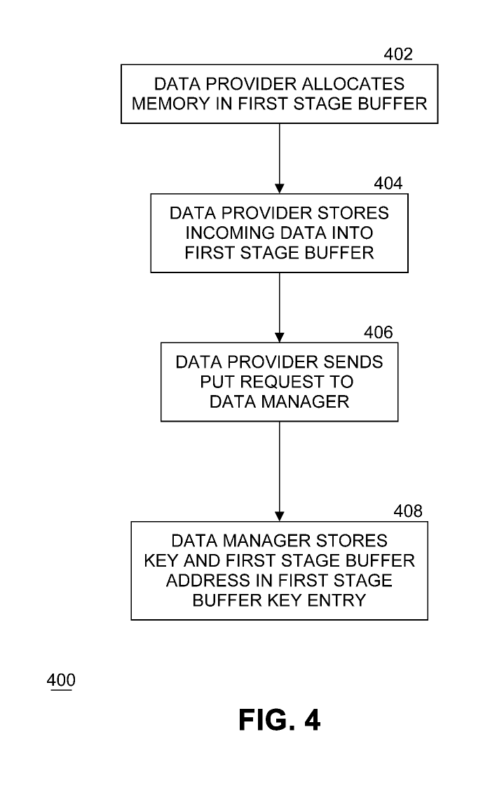

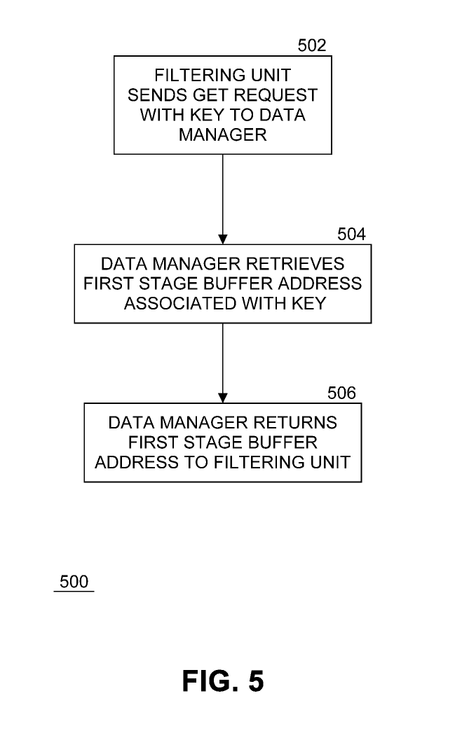

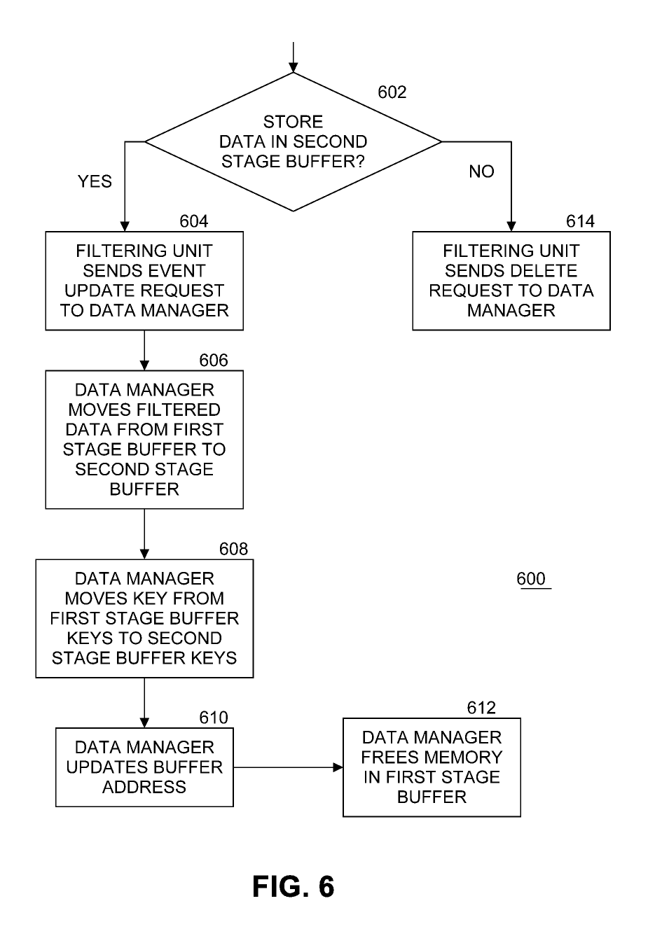

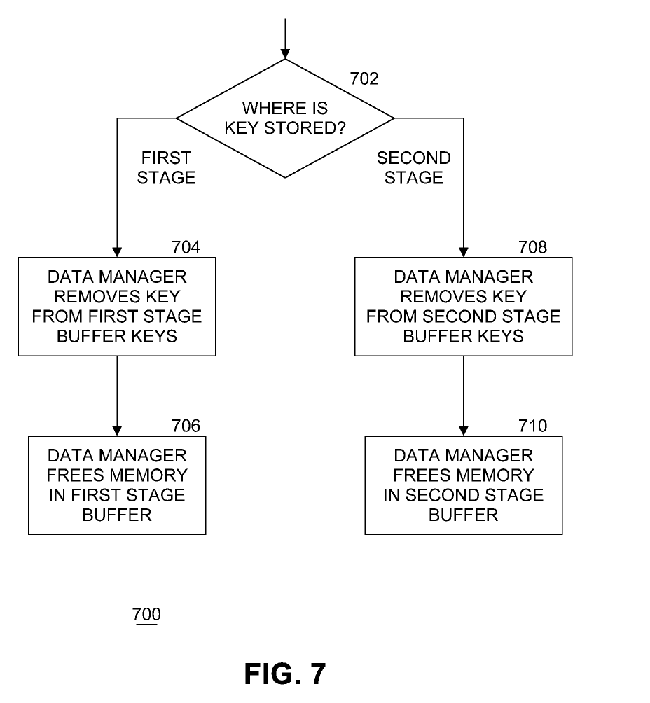

According to some examples, apparatus 300 may include first Put logic 302, Get logic 304, second Put logic 306, and Delete logic 308. First Put logic 302 may be executed or implemented by circuitry 310 to perform processing as described with reference to first Put logic flow 400 of FIG. 4. In some examples, apparatus 300 may include Get logic 304. Get logic 304 may be executed or implemented by circuitry 310 to perform processing as described with reference to Get logic flow 500 of FIG. 5. According to some examples, apparatus 300 may include second Put logic 306. Second Put logic 306 may be executed or implemented by circuitry 310 to perform processing as described with reference to second Put logic flow 600 of FIG. 6. According to some examples, apparatus 300 may include Delete logic 308. Delete logic 308 may be executed or implemented by circuitry 310 to perform processing as described with reference to Delete logic flow 700 of FIG. 7.

Various components of apparatus 300 may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Example connections include parallel interfaces, serial interfaces, and bus interfaces.

FIG. 4 illustrates an example of a logic flow for a first Put operation. First Put logic flow 400 may be representative of some or all of the operations executed by one or more logic, features, or devices described herein, such as apparatus 300. More particularly, first Put logic flow 400 may be implemented by at least first Put logic 302.

At block 402, data provider 204 allocates memory in first stage buffer 214 for storage of incoming data. Instead of sending the data in a Put request to data manager 208 at the outset (which would require the copying of large amounts of data), data provider 204 at block 404 stores the incoming data as the data is being received directly into the first stage buffer 214 in persistent memory 119. At block 406, data provider 204 sends a Put request to data manager 208. In an embodiment, the Put request includes a key identifying the data and an address in the first stage buffer where the data is being stored. Note that only the key and the first stage buffer address may be passed to data manager 208, not the data. At block 408, data manager 208 stores the key and the first stage buffer address in an entry in first stage buffer keys 210. In an embodiment, a hash table may be selected as a data structure for first stage buffer 214 because it has O(1) processing time on a Put operation, as well as good Get operation performance with correctly controlled hash sizing. There may be no need for rehashing due to the fact that the hash table can be defined in reference to a memory capacity dedicated for first stage buffer sizes.

FIG. 5 illustrates an example of a logic flow for a Get operation. Get logic flow 500 may be representative of some or all of the operations executed by one or more logic, features, or devices described herein, such as apparatus 300. More particularly, Get logic flow 500 may be implemented by at least Get logic 304. FIG. 5 shows how a Get operation request from filtering unit 202 may be optimized by data manager 208. A Get request returns an address in first stage buffer 214 where the desired data is stored. This avoids unnecessary copying of the data during filtering processing.

At block 502, filtering unit 502 sends a Get request with a key to data manager 208. The key identifies which previously received data that filtering unit 502 needs to process. At block 504, data manager 208 looks up the entry in first stage buffer keys 210 matching the key and retrieves the first stage buffer address associated with the key. At block 506, data manager 506 returns the first stage buffer address to filtering unit 202. Filtering unit 202 may then perform a filtering process on the data stored in first stage buffer 214 referenced by the returned first stage buffer address.

FIG. 6 illustrates an example of a logic flow for a second Put operation. Second Put logic flow 600 may be representative of some or all of the operations executed by one or more logic, features, or devices described herein, such as apparatus 300. More particularly, second Put logic flow 600 may be implemented by at least second Put logic 306.

When filtering unit 202 determines that a portion of the data has passed through the filtering processing and should now be stored in second stage buffer 216 for further processing, data manager 208 may be triggered to move the filtered portion of the data from first stage buffer 214 in persistent memory 119 to second stage buffer 216 in storage device 120. Data manager 208 may then free up the space used by the data in the first storage buffer.

At block 602, filtering unit 202 determines if the filtered portion of the data from first stage buffer should be stored in second stage buffer 216 for further processing. If so, filtering unit 202 at block 604 sends an event update request to data manager 208 to trigger moving the filtered portion of the data and freeing up the space used in the first stage buffer. At block 606, data manager moves the filtered portion of the data from first stage buffer 214 in persistent memory 119 to second stage buffer 216 in storage device 120. In embodiments of the present invention, unnecessary memory copying operations may be avoided because the filtered data is in the first stage buffer in persistent memory 119 within host computing platform 110, and thus is known in a system memory map of the host computing platform. At block 608, data manager 608 moves the key identifying the data from first stage buffer keys 210 to second stage buffer keys 212. At block 610, data manager 208 updates the buffer address in the entry in second stage buffer keys 212 associated with the key to the address of the data now stored in second stage buffer 216. At block 612, data manager frees the memory in first stage buffer 214 used to store the data.

In embodiments, various types of data structures may be used for second stage buffer 216. In one embodiment, a B+ Tree data structure may be used instead of a hash table data structure, because performance will be driven by disk I/O performance (e.g., of the storage device), and if the size of data is not known in advance (although the buffer size is known) then rehashing operations would be very expensive.

If at block 602 the data is to not be stored in second stage buffer 216, then at block 614 filtering unit 202 sends a Delete request to data manager 208 to delete the data from first stage buffer 214. In an embodiment, the Delete request may include the key of the data to be deleted

FIG. 7 illustrates an example of a logic flow for a Delete operation. Delete logic flow 700 may be representative of some or all of the operations executed by one or more logic, features, or devices described herein, such as apparatus 300. More particularly, Delete logic flow 700 may be implemented by at least Delete logic 308.

At block 702, data manager 208 determines where the key received from filtering unit 202 is stored, whether in first stage buffer keys 210 or second stage buffer keys 212. If the key is in first stage buffer keys 210, data manager 208 removes the key from first stage buffer keys at block 704, and frees the memory in first stage buffer 214 associated with the key at block 706. If the key is in second stage buffer keys 212, data manager 208 removes the key from second stage buffer keys 212 at block 708, and frees the memory in second stage buffer 216 associated with the key at block 710.

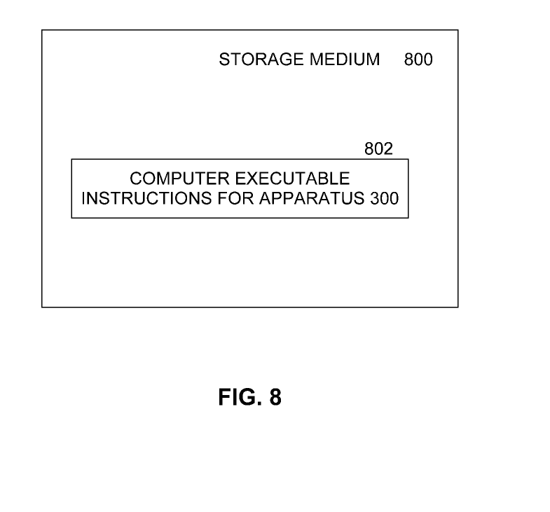

FIG. 8 illustrates an example of a storage medium 800. Storage medium 800 may comprise an article of manufacture. In some examples, storage medium 800 may include any non-transitory computer readable medium or machine readable medium, such as an optical, magnetic or semiconductor storage. Storage medium 800 may store various types of computer executable instructions, such as instructions 802 for apparatus 600 to implement logic flows 400, 500, 600, and 700. Examples of a computer readable or machine-readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

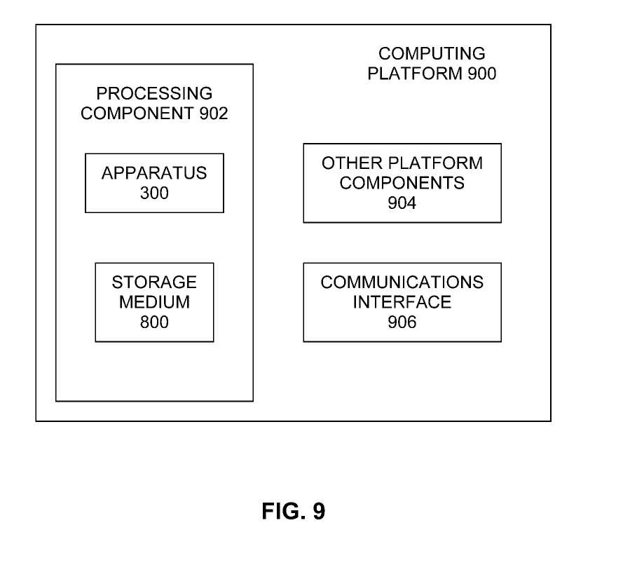

FIG. 9 illustrates an example computing platform 900. In some examples, as shown in FIG. 9, computing platform 900 may include a processing component 902, other platform components 904 and/or a communications interface 906. According to some examples, computing platform 900 may be implemented in a server, such as system 100. The server may be capable of coupling through a network to other servers and may be part of a datacenter including a plurality of network connected servers arranged to host one or more virtual machines (VMs).

According to some examples, processing component 902 may execute processing operations or logic for apparatus 300 and/or storage medium 800. Processing component 902 may include various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, device drivers, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given example.

In some examples, other platform components 904 may include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), types of non-volatile memory such as 3-D cross-point memory that may be byte or block addressable. Non-volatile types of memory may also include other types of byte or block addressable non-volatile memory such as, but not limited to, multi-threshold level NAND flash memory, NOR flash memory, single or multi-level PCM, resistive memory, nanowire memory, FeTRAM, MRAM that incorporates memristor technology, STT-MRAM, or a combination of any of the above. Other types of computer readable and machine-readable storage media may also include magnetic or optical cards, an array of devices such as Redundant Array of Independent Disks (RAID) drives, solid state memory devices (e.g., USB memory), solid state drives (SSD) and any other type of storage media suitable for storing information.

In some examples, communications interface 906 may include logic and/or features to support a communication interface. For these examples, communications interface 906 may include one or more communication interfaces that operate according to various communication protocols or standards to communicate over direct or network communication links or channels. Direct communications may occur via use of communication protocols or standards described in one or more industry standards (including progenies and variants) such as those associated with the PCIe specification. Network communications may occur via use of communication protocols or standards such those described in one or more Ethernet standards promulgated by IEEE. For example, one such Ethernet standard may include IEEE 802.3. Network communication may also occur according to one or more OpenFlow specifications such as the OpenFlow Switch Specification.

As mentioned above computing platform 900 may be implemented in a server of a datacenter. Accordingly, functions and/or specific configurations of computing platform 900 described herein, may be included or omitted in various embodiments of computing platform 100, as suitably desired for a server deployed in a datacenter.

The components and features of computing platform 900 may be implemented using any combination of discrete circuitry, ASICs, logic gates and/or single chip architectures. Further, the features of computing platform 900 may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It should be appreciated that the exemplary computing platform 900 shown in the block diagram of FIG. 9 may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASIC, programmable logic devices (PLD), digital signal processors (DSP), FPGA, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some examples may include an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Included herein are logic flows or schemes representative of example methodologies for performing novel aspects of the disclosed architecture. While, for purposes of simplicity of explanation, the one or more methodologies shown herein are shown and described as a series of acts, those skilled in the art will understand and appreciate that the methodologies are not limited by the order of acts. Some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

A logic flow or scheme may be implemented in software, firmware, and/or hardware. In software and firmware embodiments, a logic flow or scheme may be implemented by computer executable instructions stored on at least one non-transitory computer readable medium or machine readable medium, such as an optical, magnetic or semiconductor storage. The embodiments are not limited in this context.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A data acquisition apparatus comprising:
circuitry; and
a first logic for execution by the circuitry to allocate memory in a first stage buffer, to store data received by a data provider into the allocated memory in the first stage buffer, and to store a key identifying the data and an address in the first stage buffer for the stored data in an entry in a first keys data structure;
a second logic for execution by the circuitry to receive a request from a filtering unit to get the stored data from the first stage buffer, the request including the key, to retrieve the address in the first stage buffer from the entry in the first keys data structure associated with the key, and to return the address in the first stage buffer to the filtering unit; and
a third logic for execution by the circuitry to receive a request to store at least a portion of the stored data in a second stage buffer, the request including the key, to move the at least a portion of the stored data from the first stage buffer to the second stage buffer, to move the key from the first keys data structure to a second keys data structure, to update an address for the second stage buffer of the at least a portion of the stored data in the second keys data structure, and to free memory allocated to the stored data in the first stage buffer.

2. The data acquisition apparatus of claim 1, comprising:
a fourth logic for execution by the circuitry to remove the key from the first keys data structure and to free memory allocated to the stored data in the first stage buffer when the data is stored in the first stage buffer; and to remove the key from the second keys data structure and to free memory allocated to the at least a portion of the stored data in the second stage buffer when the at least a portion of the stored data is stored in the second stage buffer.

3. The data acquisition apparatus of claim 1, comprising a non-volatile persistent memory to store the first stage buffer, the first keys data structure, and the second keys data structure.

4. The data acquisition apparatus of claim 3, comprising a non-volatile storage device to store the second stage buffer, the non-volatile storage device comprising one of a hard disk drive and a solid-state disk drive.

5. The data acquisition apparatus of claim 3, comprising a system memory device to store the second stage buffer.

6. The data acquisition apparatus of claim 1, comprising the first stage buffer to store data not filtered by the filtering unit and the second stage buffer to store data filtered by the filtering unit.

7. A method comprising:
allocating memory in a first stage buffer;
storing data received by a data provider into the allocated memory in the first stage buffer;
storing a key identifying the stored data and an address in the first stage buffer for the stored data in an entry in a first keys data structure;
receiving a request from a filtering unit to get the stored data from the first stage buffer, the request including the key;
retrieving the address in the first stage buffer from the entry in the first keys data structure associated with the key;
returning the address in the first stage buffer to the filtering unit;
receiving a request to store at least a portion of the stored data in a second stage buffer, the request including the key;
moving the at least a portion of the stored data from the first stage buffer to the second stage buffer;
moving the key from the first keys data structure to a second keys data structure;
updating an address for the second stage buffer of the at least a portion of the stored data in the second keys data structure; and
freeing memory allocated to the stored data in the first stage buffer.

8. The method of claim 7, comprising:
removing the key from the first keys data structure and freeing memory allocated to the stored data in the first stage buffer when the data is stored in the first stage buffer; and
removing the key from the second keys data structure and freeing memory allocated to the at least a portion of the stored data in the second stage buffer when the at least a portion of the stored data is stored in the second stage buffer.

9. The method of claim 7, comprising:
storing the first stage buffer, the first keys data structure, and the second keys data structure in a non-volatile persistent memory in a computing platform.

10. The method of claim 9, comprising:
storing the second stage buffer in a non-volatile storage device, the non-volatile storage device comprising one of a hard disk drive and a solid-state disk drive.

11. The method of claim 9, comprising:
storing the second stage buffer in a system memory device in the computing platform.

12. The method of claim 7, comprising:
storing data not filtered by the filtering unit in the first stage buffer; and
storing data filtered by the filtering unit in the second stage buffer.

13. At least one machine readable medium comprising a plurality of instructions that in response to being executed by a system at a computing platform cause the system to:
allocate memory in a first stage buffer;
store data received by a data provider into the allocated memory in the first stage buffer;
store a key identifying the stored data and an address in the first stage buffer for the stored data in an entry in a first keys data structure;
receive a request from a filtering unit to get the stored data from the first stage buffer, the request including the key;
retrieve the address in the first stage buffer from the entry in the first keys data structure associated with the key;
return the address in the first stage buffer to the filtering unit;
receive a request to store at least a portion of the stored data in a second stage buffer, the request including the key;
move the at least a portion of the stored data from the first stage buffer to the second stage buffer;
move the key from the first keys data structure to a second keys data structure;
update an address for the second stage buffer of the at least a portion of the stored data in the second keys data structure; and
free memory allocated to the stored data in the first stage buffer.

14. The at least one machine readable medium of claim 13, comprising the instructions to further cause the system to:
remove the key from the first keys data structure and free memory allocated to the stored data in the first stage buffer when the data is stored in the first stage buffer; and
remove the key from the second keys data structure and free memory allocated to the at least a portion of the stored data in the second stage buffer when the at least a portion of the stored data is stored in the second stage buffer.

15. The at least one machine readable medium of claim 13, comprising the instructions to further cause the system to:
store the first stage buffer, the first keys data structure, and the second keys data structure in a non-volatile persistent memory in a computing platform.

16. The at least one machine readable medium of claim 15, comprising the instructions to further cause the system to:
store the second stage buffer in a non-volatile storage device, the non-volatile storage device comprising one of a hard disk drive and a solid-state disk drive.

17. The at least one machine readable medium of claim 15, comprising the instructions to further cause the system to:
store the second stage buffer in a system memory device in the computing platform.

18. The at least one machine readable medium of claim 13, comprising the instructions to further cause the system to:
store data not filtered by the filtering unit in the first stage buffer; and
store data filtered by the filtering unit in the second stage buffer.

19. A data acquisition system comprising:
a data provider to allocate memory in a first stage buffer, and to store data received by the data provider from external sensors into the allocated memory in the first stage buffer; and
a data manager to store a key identifying the stored data and an address in the first stage buffer for the stored data in an entry in a first keys data structure, to receive a request to get the stored data from the first stage buffer, the request including the key, to retrieve the address in the first stage buffer from the entry in the first keys data structure associated with the key, to return the address in the first stage buffer to the filtering unit, to receive a request to store at least a portion of the stored data in a second stage buffer, the request including the key, to move the at least a portion of the stored data from the first stage buffer to the second stage buffer, to move the key from the first keys data structure to a second keys data structure, to update an address for the second stage buffer of the at least a portion of the stored data in the second keys data structure, and to free memory allocated to the stored data in the first stage buffer.

20. The data acquisition system of claim 19, comprising:
a filtering unit to send the request to get the stored data from the first stage buffer, to filter the stored data, and to send the request to store at least a portion of the stored data in the second stage buffer.

21. The data acquisition system of claim 19, wherein the data manager is configured to remove the key from the first keys data structure and to free memory allocated to the stored data in the first stage buffer when the data is stored in the first stage buffer; and to remove the key from the second keys data structure and to free memory allocated to the at least a portion of the stored data in the second stage buffer when the at least a portion of the stored data is stored in the second stage buffer.

22. The data acquisition system of claim 19, comprising a non-volatile persistent memory to store the first stage buffer, the first keys data structure, and the second keys data structure.

23. The data acquisition system of claim 22, comprising a non-volatile storage device to store the second stage buffer, the non-volatile storage device comprising one of a hard disk drive and a solid-state disk drive.

24. The data acquisition system of claim 22, comprising a system memory device to store the second stage buffer.

25. The data acquisition system of claim 20, wherein the first stage buffer to store data not filtered by the filtering unit and the second stage buffer to store data filtered by the filtering unit.

26. The data acquisition system of claim 19, wherein the second stage buffer comprises a B+ tree.
